(19) United States
(12) Patent Application Publication
(10) Pub. No.: US 2016/0192219 A1
(43) Pub. Date: Jun. 30, 2016

(54) METHOD FOR ASSIGNING RADIO RESOURCE AND COMMUNICATION SYSTEM SUPPORTING THE SAME

(71) Applicant: ELECTRONICS AND TELECOMMUNICATIONS RESEARCH INSTITUTE, Daejeon (KR)

(72) Inventor: Min Suk CHOI, Daejeon (KR)

(73) Assignee: ELECTRONICS AND TELECOMMUNICATIONS RESEARCH INSTITUTE, Daejeon (KR)

(21) Appl. No.: 14/955,032

(22) Filed: Nov. 30, 2015

(30) Foreign Application Priority Data
Dec. 30, 2014 (KR) 10-2014-0192953
Jul. 27, 2015 (KR) 10-2015-0105797

(51) Int. Cl. H04W 24/08; H04W 72/04; H04W 74/08; H04W 72/08

(52) U.S. Cl. CPC H04W 24/08; H04W 72/082; H04W 72/0453; H04W 72/0406; H04W 74/0866

(57) ABSTRACT

Disclosed is a method for assigning a radio resource. The method includes: measuring an interference or a noise level for a signal outputted from neighboring base stations and generating interference information corresponding to the measured value; receiving a frequency assignment list which is available for access for each interference state of a terminal from a serving base station via a control channel; selecting specific frequency assignment information from among the frequency assignment list based on the interference information; transmitting the selected frequency assignment information to the base station; and being assigned the radio resource by the base station based on the selected frequency assignment information.

### CROSS-REFERENCE TO RELATED APPLICATION

This application claims the benefit of priority to Korean Patent Application No. 10-2014-0192953, filed on Dec. 30, 2014, Korean Patent Application NO. 10-2015-0105797, filed on Jul. 27, 2015 in the Korean Intellectual Property Office, the disclosure of which is incorporated herein in its entirety by reference.

### BACKGROUND OF THE INVENTION

1. Field of the Invention

The present disclosure relates to a method for assigning a radio resource in a wireless communication environment and a communication system supporting the same, and more particularly, to a method for assigning a radio resource by a terminal with a minimal interference by minimizing the interference caused by various radio environments, and a communication system supporting the same.

2. Description of the Related Art

A wireless communication system provides a wide range of mobile communication environments, such as HSDPA, HSUPA, LTE, LTE-A based on a 3GPP, and supports a high-speed radio data transmission service. The above-described wireless communication system supports various service types to meet an increasing data traffic demand.

For example, the wireless communication system supports a MIMO technology to create multi spaces on a radio channel based on multiple input multiple output (MIMO) antenna, and to increase the amount of data transmission by increasing a channel in proportion to the number of the antennas. The MIMO technology includes a SU-MIMO to transmit to a single terminal, and a MU-MIMO to transmit to multiple terminals using the same time and frequency resource.

Recently, the mobile communication system supports an OFDM method in a connection type. In addition, OFDMA method is also widely used to differently divide and assign a valid sub-carrier group by extending a multiplexing technology that transmits a divided multi-carrier with multiple channels in a limited frequency.

Recently, a wireless technology market, in particular, a smartphone market, has been rapidly expanded. Accordingly, due to the use of various applications installed in the smart phone, a user traffic amount is increased in a wireless communication environment, and as a result, a traffic loading phenomenon occurs. In order to solve this problem, base stations are densely built in a heavy traffic area to satisfy a need of a user. However, excessive base station construction leads to an excessive radio environment, thereby increasing an interference to cause discomfort when using a service. In order to solve the above problems, the 3GPP provides various technologies for interference cancellation.

For example, the 3GPP provides a CoMP technology. The CoMP technology is a technology to reduce interference between cells and increase a throughput of a terminal in a boundary of cells by enabling to accomplish a communication from other adjacent cells as well as a serving cell in cooperation with other cells in order to increase the throughput of the terminal.

In addition, the 3GPP provides an ICIC technology. The ICIC technology is an interference control technology of an LTE system defined in 3GPP release 8 and is a technology of reducing the interference between cells by using different frequency resources by terminals between adjacent cells. A base station providing the ICIC may assign a radio resource to the terminal to identify the interference situation of neighboring cells through a X2 interface and avoid interference.

However, rather than the above-described indirect removal (or control) technology, it is preferable that the base station checks interference information of the current terminal, checks whether the terminal located in the current base station is a terminal having an interference or having no interference, and perform a scheduling that can minimize the interference to the terminal.

### SUMMARY OF THE INVENTION

The present disclosure has been made in view of the above problems, and provides a method of selecting a radio resource assignment by utilizing interference information that a terminal measured based on static frequency assignment (FA) selection information.

The present disclosure further provides a method of transmitting interference information measured by a terminal to a base station and assigning a radio resource having an interference minimized by the base station based on terminal interference information to the terminal.

The present disclosure further provides a method of cancelling interference in a wireless communication system by sharing data based on terminal information, or based on the base station on the basis of interference information of neighboring base station measured by a signal-to-interference plus noise ratio (SINR) value of the terminal.

In accordance with an aspect of the present disclosure, a method for assigning a radio resource includes: measuring an interference or a noise level for a signal outputted from neighboring base stations and generating interference information corresponding to the measured value; receiving a frequency assignment list which is available for access for each interference state of a terminal from a serving base station via a control channel; selecting specific frequency assignment information from among the frequency assignment list based on the interference information; transmitting the selected frequency assignment information to the base station; and being assigned the radio resource by the base station based on the selected frequency assignment information.

Receiving a frequency assignment list includes receiving a frequency assignment list included in a system information block of a broadcast control channel.

Receiving a frequency assignment list includes selecting the specific frequency assignment information to minimize the interference from the neighboring base stations.

In accordance with another aspect of the present disclosure, a method for assigning a radio resource includes: measuring an interference or a noise level for a signal outputted from neighboring base stations and generating interference information corresponding to the measured value; including information corresponding to the interference information in a specific frame of a random access channel; transmitting the specific frame to a serving base station; and being assigned the radio resource by the base station based on the information corresponding to the interference information included in the specific frame.

Including information includes including specified information in the specific frame when the terminal is in a state of interference.

In accordance with another aspect of the present disclosure, a method for assigning a radio resource includes: measuring an interference or a noise level for a signal from neighboring base stations and generating base station interference information based on the measured value; transmitting the base station interference information to a serving base station via a common control channel; and being assigned the radio resource by the base station based on the base station interference information.

Generating base station interference information includes including information of at least one base station from which the terminal is affected by the interference from among the neighboring base stations in the base station interference information.

Transmitting the base station interference information includes including the base station interference information in a radio resource control connection request message and transmitting the message.

In accordance with another aspect of the present disclosure, a radio resource assignment system may include a base station configured to assign a radio resource, and at least one terminal located in a coverage of the base station, wherein the base station generates a frequency assignment list which is available for access for each interference state of the terminal, and transmits the frequency assignment list to the terminal via a control channel, the terminal measures an interference or noise level for a signal from neighboring base stations and generates interference information corresponding to the measured value, selects specific frequency assignment information from among the frequency assignment list based on the interference information, transmits the selected frequency assignment information to the base station, and the base station assigns the radio resource to the terminal based on the selected frequency assignment information.

The base station may include the frequency assignment list in a system information block of a broadcast control channel and transmit to the terminal.

The terminal may select the specific frequency assignment information to minimize interference from neighboring base stations.

In accordance with another aspect of the present disclosure, a radio resource assignment system may include a base station configured to assign a radio resource, and at least one terminal located in a coverage of the base station, wherein the terminal measures the interference or noise level for a signal from neighboring base stations and generates interference information corresponding to the measured value, includes information corresponding to the interference information in a specific frame of a random access channel, transmits the specific frame to the base station, and the base station assigns the radio resource to the terminal based on the information corresponding to the interference information included in the specific frame.

The terminal may include specified information in the specific frame when the terminal is in a state of interference.

In accordance with another aspect of the present disclosure, a radio resource assignment system may include a base station configured to assign a radio resource, and at least one terminal located in a coverage of the base station, wherein the terminal measures the interference or noise level for a signal from neighboring base stations and generates base station interference information based on the measured value, transmits the base station interference information to the base station via a common control channel, and the base station assigns the radio resource to the terminal based on the base station interference information.

The terminal includes information of at least one base station from which the terminal is affected by the interference from among the neighboring base stations in the base station interference information.

The terminal includes the base station interference information in a radio resource control connection request message and transmits the message.

In accordance with another aspect of the present disclosure, a method for assigning a radio resource may include an operation of generating, by a base station, a first frequency assignment (FA) list which can be selected by a terminal located in a coverage of the base station when an interference exists and a second FA list which can be selected when the interference does not exist, an operation of transmitting, by the base station, the first FA list and the second FA list to the terminal via the control channel (CCH), an operation of selecting, by the terminal, a specific FA through the first FA list and the second FA list based on the interference information which is measured by a current signal-to-interference plus noise ratio (SINR) value, an operation of transmitting, by the terminal, the specific FA to the base station through a random access channel (RACH), and an operation of assigning, by the base station, the radio resource by performing a scheduling based on the specific FA selected by the terminal.

The operation of transmitting the first FA list and the second FA list to the terminal via the CCH may include an operation of including the first FA list and the second FA list in a system information blocks (SIB) of broadcast control channel (BCCH) and transmitting to the terminal.

In accordance with another aspect of the present disclosure, a method for assigning a radio resource may include transmitting, by the base station, a system information blocks (SIB) to the terminal located in a coverage of the base station; determining, by the terminal, a Group of a random access channel (RACH) Preamble message based on the interference information measured by the current signal-to-interference plus noise ratio (SINR) value; transmitting, by the terminal, the RACH Preamble message to the base station; selecting, by the base station, a specific frequency assignment (FA) in the FA list according to the Group of the RACH Preamble message; and assigning, by the base station, a radio resource to the terminal based on the specific FA.

Determining the Group may include additionally defining the Group C in the RACH Preamble message when the terminal is currently affected by the interference.

In accordance with another aspect of the present disclosure, a method for assigning a radio resource may include: transmitting, by the base station, the system information blocks (SIB) to the terminal located in a coverage of the base station; transmitting, by the terminal, the random access channel (RACH) Preamble message to the base station; transmitting, by the base station, the response to the RACH Preamble message to the terminal; generating, by the terminal, an interference base station list currently affected by the interference based on the signal-to-interference plus noise ratio (SINR) value; including, by the terminal, the interference base station list in the radio resource control (RRC) connection request message of uplink (UL) common control channel (CCCH) and transmitting to the base station; selecting, by the base station, a specific frequency assignment (FA) in a FA list by analyzing the interference base station list; and assigning, by the base station, a radio resource to the terminal based on the specific FA.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating a configuration of a neighboring radio wave interference measurement and information transmission and reception of a communication system according to an embodiment of the present disclosure;

FIG. 2 is a diagram illustrating a method for assigning a radio resource based on base station information according to an embodiment of the present disclosure;

FIG. 3 is a diagram illustrating a method for assigning a radio resource based on interference state information of a terminal according to an embodiment of the present disclosure;

FIG. 4 is a diagram illustrating a method for assigning a radio resource based on interference factor base station information of a terminal according to an embodiment of the present disclosure;

FIG. 5 is a flow chart illustrating a method of operating a terminal in association with FIG. 2;

FIG. 6 is a flow chart illustrating a method of operating a terminal in association with FIG. 3;

FIG. 7 is a flow chart illustrating a method of operating a terminal in association with FIG. 4; and

FIG. 8 is a diagram illustrating an example of implementing a communication system according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

In this specification, a terminal may refer to a wireless transmit/receive unit (WTRU), an user equipment (UE), a user terminal (UT), an access terminal (AT), a mobile station (MS), a mobile terminal, a subscriber unit, a subscriber station (SS), a wireless device, or a mobile subscriber unit, or the like, and may include any or all features of those elements.

Here, the terminal may include a desktop computer, a laptop computer, a tablet PC, a wireless phone, a mobile phone, a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, and the like which can perform a communication.

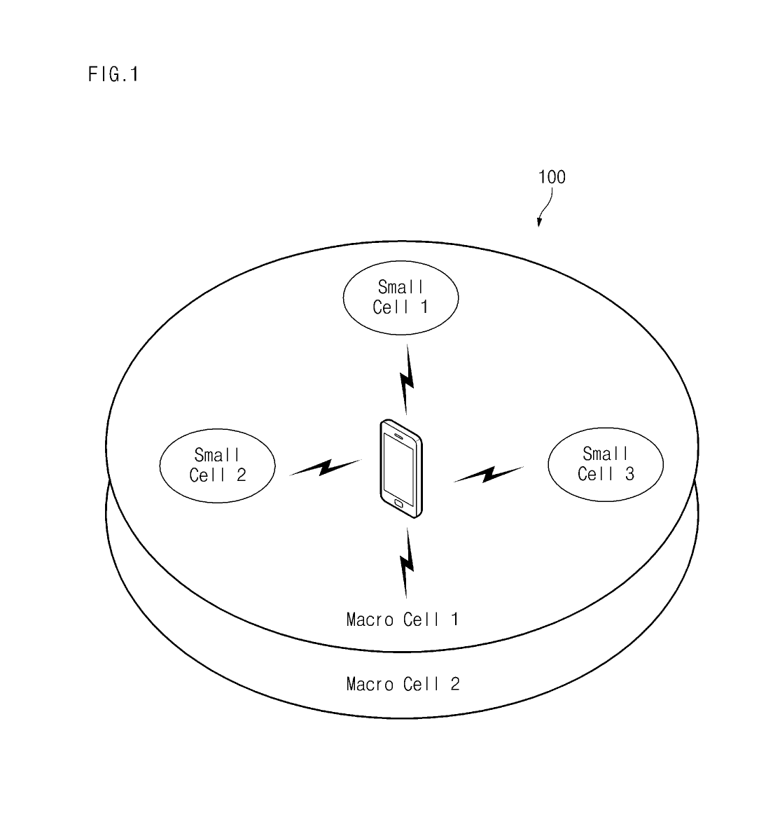

FIG. 1 is a diagram illustrating a configuration of a neighboring radio wave interference measurement and information transmission and reception of a communication system according to an embodiment of the present disclosure. The communication system according to an embodiment of the present disclosure may include a base station and a terminal.

Referring to FIG. 1, when the terminal exists in various base station coverage such as a heterogeneous network (e.g., HetNets) 100, at least one of the terminal or the base station may measure interference information on a surrounding radio wave. Further, the terminal or the base station may mutually transmit and receive a radio resource including the interference information.

According to various embodiments, in the method for assigning a radio resource proposed by the present disclosure, the method of measuring interference information on a surrounding radio wave and sending the interference information may be mainly divided into two types. One of the two types is a base station information based method, and the other is a terminal information based method.

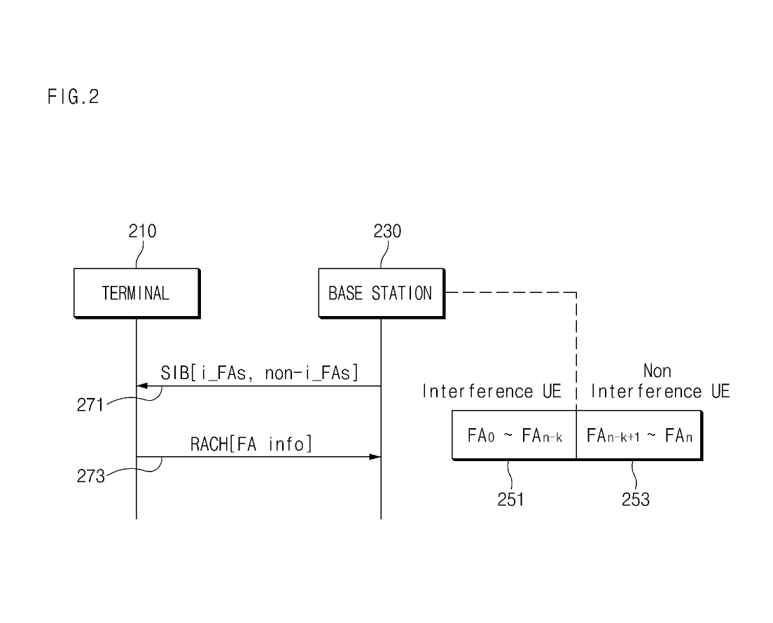

FIG. 2 is a diagram illustrating a method for assigning a radio resource based on base station information according to an embodiment of the present disclosure.

Referring to FIG. 2, the base station 230 may generate frequency assignment (FA) information which can be adaptively selected according to the presence or absence of interference of a terminal 210 which is serviced from the base station 230. The FA information may include a FA list 251 when the interference exists and a FA list 253 when the interference does not exist.

According to various embodiments, since the current base station 230 is difficult to intuitively recognize the interference information of the terminal 210 located in a coverage, the current base station 230 may send the FA information to the terminal 210 so that the terminal 210 may select corresponding information.

In this regard, the base station 230 may transmit the FA information via a control channel (CCH). In an embodiment, at operation 271, the base station 230 may include the FA information in a system information block (SIB) of a broadcast control channel (BCCH) and transmit.

According to various embodiments, the terminal 210 may map the interference information measured by the interference for a current signal or a noise level (e.g., SINR) and the SIB information. Thus, the terminal 210 may select the FA information corresponding to the interference information among the FA list 251 when the interference exists and the FA list 253 when the interference does not exist.

At operation 273, the terminal 210 may transmit the selected FA information to the base station 230 via a random access channel (RACH). The base station 230 may assign the radio resource to the terminal 210 by performing a scheduling based on the selected FA information.

As described above, according to various embodiments, the method for assigning a radio resource may include an operation of generating, by a base station, a first FA list which can be selected by a terminal located in a coverage of the base station when an interference exists and a second FA list which can be selected when the interference does not exist, an operation of transmitting, by the base station, the first FA list and the second FA list to the terminal via the CCH, an operation of selecting, by the terminal, a specific FA through the first FA list and the second FA list based on the interference information which is measured by a current SINR value, an operation of transmitting, by the terminal, the specific FA to the base station through a RACH, and an operation of assigning, by the base station, the radio resource by performing a scheduling based on the specific FA selected by the terminal.

According to various embodiments, the operation of transmitting the first FA list and the second FA list to the terminal via the CCH may include an operation of including the first FA list and the second FA list in a SIB of BCCH and transmitting to the terminal.

According to various embodiments, the method for assigning a radio resource may include a terminal information based method which is another method for measuring interference information on a surrounding radio wave and transmitting the interference information on a surrounding radio wave. For example, the terminal may measure the interference information of a surrounding base station through a SINR and collect information on whether the terminal is currently affected by the interference, or which base station affects if the terminal is affected by the interference. The terminal information based method may be divided into two types which are described later according to the method for sending the collected interference information to the base station.

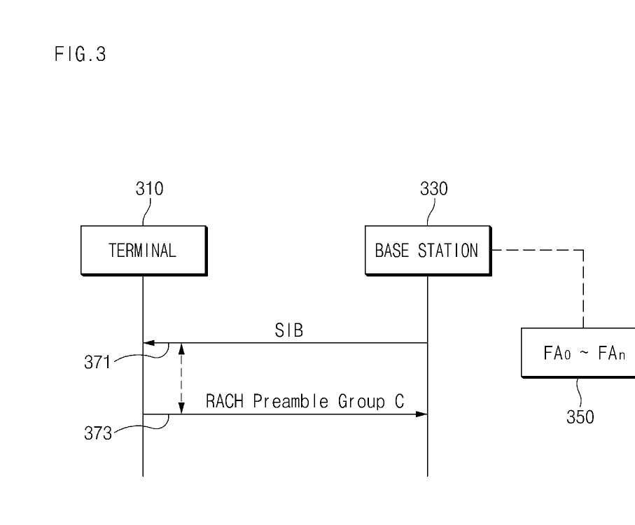

FIG. 3 is a diagram illustrating a method for assigning a radio resource based on interference state information of a terminal according to an embodiment of the present disclosure.

Referring to FIG. 3, a terminal 310 may receive the SIB at operating 371, and may transmit a RACH Preamble message to a base station 330 at operation 373. In this case, the terminal 310 may generate the interference information of the neighboring base station as the SINR value currently measured by the terminal 310, and may additionally define Group C in the RACH Preamble message and send to the base station 330 if the interference exists.

The above-described method is a method of transmitting the interference state information on whether the terminal 310 is currently affected by the interference to the base station 330. The interference state information may be transmitted through the RACH Preamble message in a procedure of registering the base station 330 by the terminal 310. In this regard, if the terminal 310 is currently affected by the interference according to a result of collecting the interference information as the SINR by the terminal 310, the RACH Preamble Group C may be transmitted to the base station 330. Therefore, the base station 330 may estimate that a corresponding terminal 310 is the terminal which is currently affected by the interference, when receiving the RACH Preamble Group C message. In addition, the base station 330 may select the FA information that can minimize the interference from among a FA list 350, and may assign the radio resource to the terminal 310 based on the FA information.

As described above, according to various embodiments, the method for assigning a radio resource may include an operation of transmitting, by the base station, a SIB to the terminal located in a coverage of the base station, an operation of determining, by the terminal, a Group of a RACH Preamble message based on the interference information measured by the current SINR value, an operation of transmitting, by the terminal, the RACH Preamble message to the base station, an operation of selecting, by the base station, a specific FA in the FA list according to the Group of the RACH Preamble message, and an operation of assigning, by the base station, a radio resource to the terminal based on the specific FA.

According to various embodiments, the operation of determining the Group may include an operation of additionally defining the Group C in the RACH Preamble message when the terminal is currently affected by the interference.

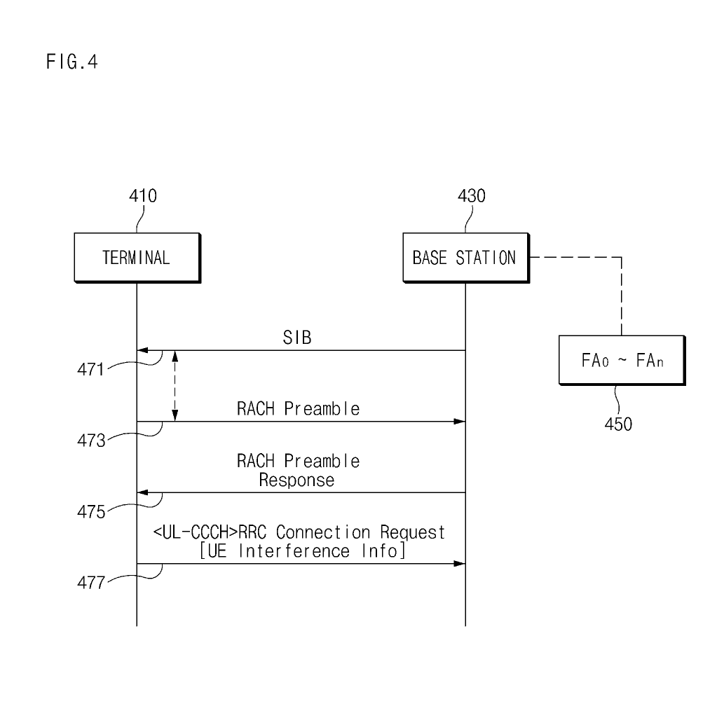

FIG. 4 is a diagram illustrating a method for assigning a radio resource based on interference factor base station information of a terminal according to an embodiment of the present disclosure.

Referring to FIG. 4, as described above in FIG. 3, a terminal 410 may receive the SIB at operating 471, and may transmit a RACH Preamble message to a base station 430 at operation 473. However, as shown, instead of sending the RACH Preamble Group C so as to correspond to the interference information of a surrounding base station at operation 473, the terminal 410 may receive a response to the RACH Preamble message at operation 475, and then, generate information on a base station from which the terminal 410 is currently affected by the interference in radio resource control (RRC) connection request information and transmit the generated information to the base station 430.

Unlike the method in FIG. 3, the above-described method is a method of generating a list of the base station from which the terminal 410 is currently affected by the interference and sending corresponding information to the serving base station 430. As shown in FIG. 4, after receiving the RACH Preamble Response message from the base station 430, the terminal 410 may include interference base station list information in a RRC connection request message of uplink (UL) common control channel (CCCH) and transmit to the base station 430. In this case, the serving base station 430 may select the FA information which can minimize the interference by analyzing the interference base station list from among the RRC connection request message of UL CCCH and may assign a radio resource to the terminal 410 based on the FA information.

As described above, according to various embodiments, the method for assigning a radio resource may include an operation of transmitting, by the base station, the SIB to the terminal located in a coverage of the base station, an operation of transmitting, by the terminal, the RACH Preamble message to the base station, an operation of transmitting, by the base station, the response to the RACH Preamble message to the terminal, an operation of generating, by the terminal, an interference base station list currently affected by the interference based on the SINR value, an operation of including, by the terminal, the interference base station list in the RRC connection request message of UL CCCH and transmitting to the base station, an operation of selecting, by the base station, a specific FA in a FA list by analyzing the interference base station list, and an operation of assigning, by the base station, a radio resource to the terminal based on the specific FA.

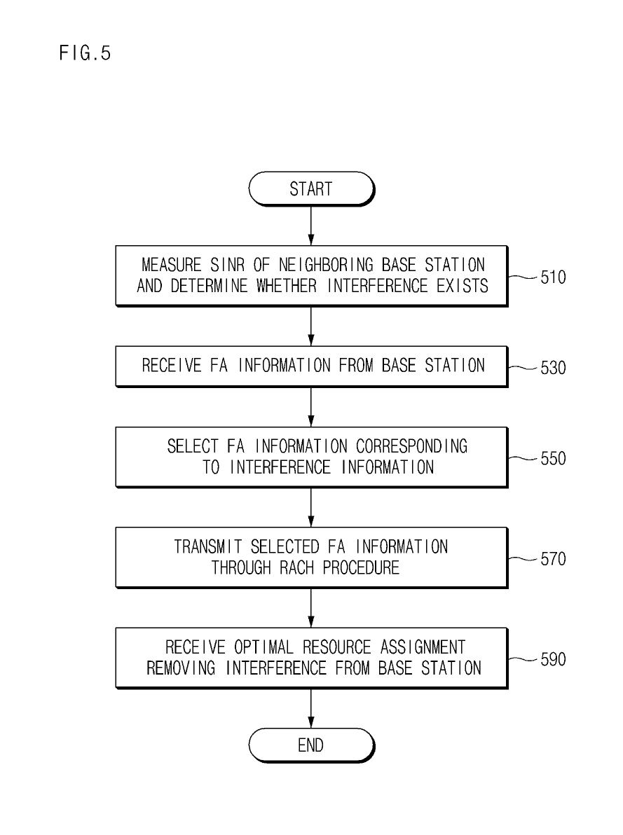

FIG. 5 is a flow chart illustrating a method of operating a terminal in association with FIG. 2.

Referring to FIG. 5, at operation 510, the terminal may measure a SINR value of neighboring base station and may determine whether interference exists based on the SINR value. At operation 530, the terminal may receive FA information which can be adaptively selected according to the presence or absence of interference of the terminal from the base station. For example, the terminal may receive the FA information transmitted to a control channel (CCH). In an embodiment, the terminal may receive the FA information included in a system information block (SIB) of a broadcast control channel (BCCH).

At operation 550, the terminal may map the interference information measured based on the SINR value to the SIB information and select the FA information corresponding to the interference information. At operation 570, the terminal may transmit the selected FA information to the base station through a RACH procedure. At operation 590, the terminal may be assigned an optimal radio resource which removed interference from the base station based on the selected FA information.

As described above, according to various embodiments, the method for assigning a radio resource may include an operation of measuring the interference or noise level for a signal from neighboring base stations and generating interference information corresponding to the measured value, an operation of receiving a frequency assignment list which is available for access for each interference state of the terminal from a serving base station via a control channel, an operation of selecting specific frequency assignment information from among the frequency assignment list based on the interference information, an operation of transmitting the selected frequency assignment information to the base station, and an operation of being assigned, by the base station, the radio resource based on the selected frequency assignment information.

According to various embodiments, the operation of receiving a frequency assignment list may include an operation of receiving a frequency assignment list included in a system information block of a broadcast control channel.

According to various embodiments, the operation of selecting specific frequency assignment information may include an operation of selecting specific frequency assignment information to minimize interference from neighboring base stations.

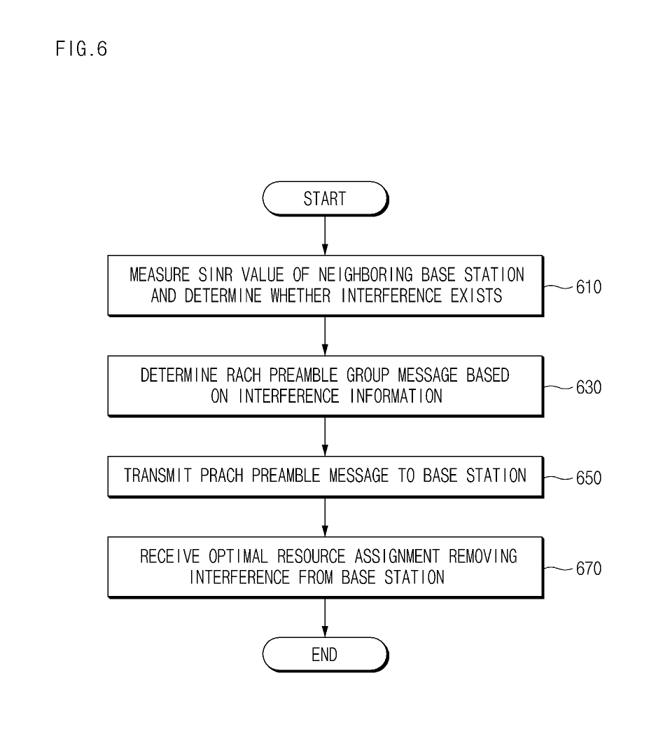

FIG. 6 is a flow chart illustrating a method of operating a terminal in association with FIG. 3.

Referring to FIG. 6, at operation 610, the terminal may measure a SINR value of a neighboring base station and may determine whether interference exists based on the SINR value. At operation 630, the terminal may determine a RACH Preamble Group message based on the interference information measured by the SINR value. For example, the terminal may additionally define Group A, Group B, or Group C in a RACH Preamble message depending on the presence or absence of the interference information and transmit. In an embodiment, the terminal may additionally define Group C in the RACH Preamble message if interference exists.

At operation 650, the terminal may transmit a PRACH Preamble message to the base station. In this case, if Group C exists in the RACH Preamble message, the base station may estimate that the terminal is a terminal which is currently affected by the interference, and may select the FA information to minimize the interference from among the FA list. At operation 670, the terminal may be assigned an optimal radio resource which removed interference from the base station based on the FA information.

As described above, according to various embodiments, an operation of the method for assigning a radio resource may include an operation of measuring the interference or noise level for a signal from neighboring base stations and generating interference information corresponding to the measured value, an operation of including information corresponding to the interference information in a specific frame of random access channel, an operation of transmitting the specific frame to a serving base station, and an operation of being assigned, by the base station, the radio resource based on the information corresponding to the interference information included in the specific frame.

According to various embodiments, the operation of including information may include an operation of including specified information in the specific frame when the terminal is in a state of interference.

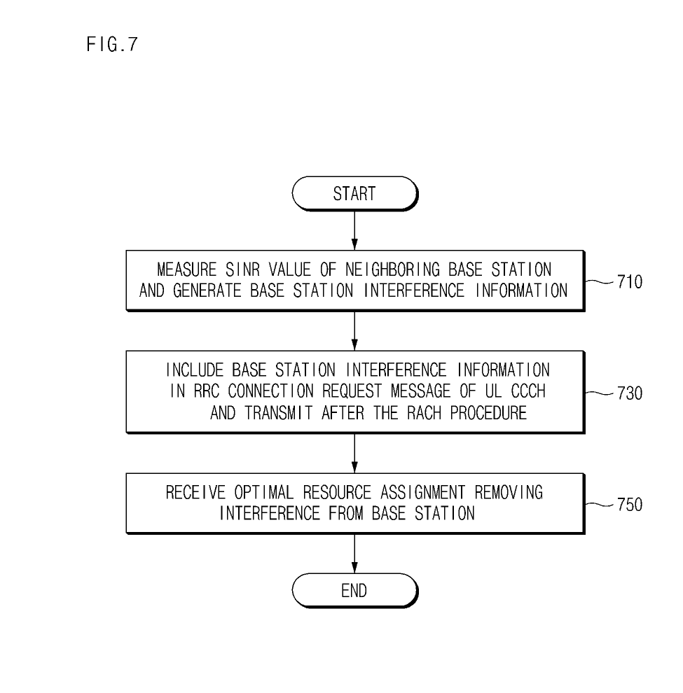

FIG. 7 is a flow chart illustrating a method of operating a terminal in association with FIG. 4.

Referring to FIG. 7, at operation 710, the terminal may measure a SINR value of a neighboring base station and may generate base station interference information (eNB interference information) based on the SINR value. The base station interference information may be list information of interference base station from which the terminal is currently affected by the interference.

At operation 730, the terminal may include the base station interference information in the RRC Connection Request message of UL CCCH and transmit to the base station, after the RACH procedure. In this case, the base station may analyze the base station interference information in the RRC Connection Request message of UL CCCH, and may select the FA information which can minimize interference based on the analyzed information. At operation 750, the terminal may be assigned an optimal radio resource which removed interference from the base station based on the FA information.

As described above, according to various embodiments, the method for assigning a radio resource may include an operation of measuring the interference or noise level for a signal from neighboring base stations and generating the base station interference information based on the measured value, an operation of transmitting the base station interference information to a serving base station via a common control channel, and an operation of being assigned, by the base station, the radio resource based on the base station interference information.

According to various embodiments, the operation of generating the base station interference information may include an operation of including information of at least one base station from which the terminal is affected by the interference from among the neighboring base stations in the base station interference information.

According to various embodiments, the operation of transmitting to the base station may include an operation of including the base station interference information in a radio resource control connection request message and transmitting the message.

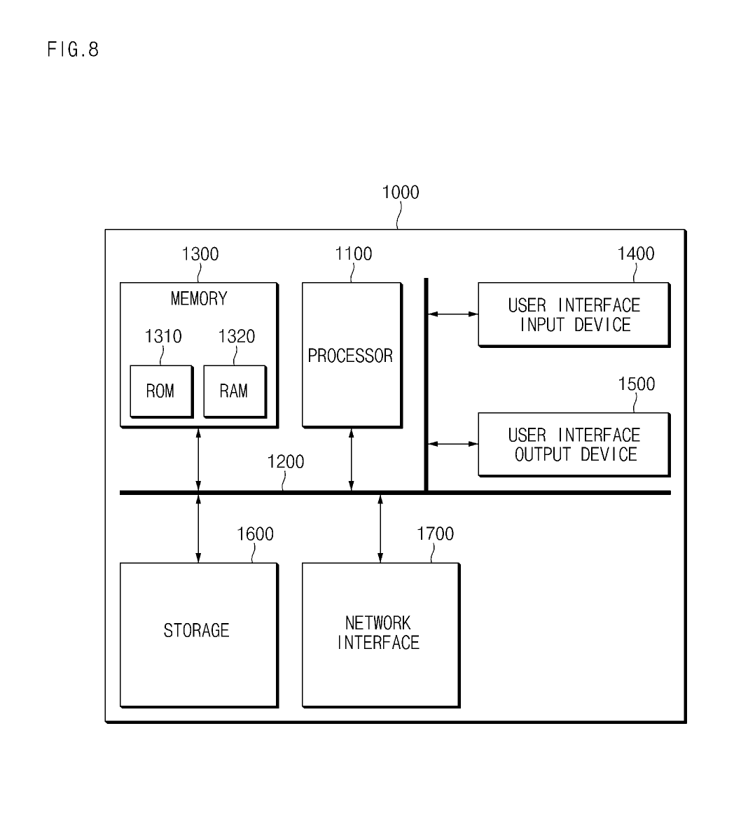

FIG. 8 is a diagram illustrating an example of implementing a communication system according to an embodiment of the present disclosure.

The communication system according to one embodiment of the present disclosure may include a base station and a terminal, and may be configured of hardware, software, or a combination of the two. For example, the communication system may be implemented by a computing system 1000 shown in FIG. 8.

Referring to FIG. 8, the computing system 1000 may include at least one processor 1100, a memory 1300, a user interface input device 1400, a user interface output device 1500, a storage 1600, and a network interface 1700 which are connected via a bus 1200.

The processor 1100 may be a semiconductor device for performing processing for the instructions stored in a central processing unit (CPU) or the memory 1300 and/or the storage 1600. The memory 1300 and the storage 1600 may include various types of volatile or nonvolatile storage media. For example, the memory 1300 may include a Read Only Memory (ROM) and a Random Access Memory (RAM).

Accordingly, the method or the step of algorithm which is mentioned above in association with the embodiments of the present disclosure may be directly implemented by a hardware, a software module, or a combination of the two executed by the processor 1100. The software module may reside in a storage medium, that is, in the memory 1300 and/or the storage 1600 such as a RAM memory, a flash memory, a ROM memory, an EPROM memory, an EEPROM memory, a register, a hard disk, a removable disk, and CD-ROM. The exemplary storage medium may be coupled to the processor 1100, and the processor 1100 may read information from the storage medium and write information to the storage medium. Alternatively, the storage medium may be integrated in the processor 1100. The processor and the storage medium may reside in an application specific integrated circuit (ASIC). The ASIC may reside in a user terminal. Alternatively, the processor and the storage medium may reside in the user terminal as an individual component.

As described above, according to various embodiments, a radio resource assignment system may include a base station configured to assign a radio resource, and at least one terminal located in a coverage of the base station, wherein the base station generates a frequency assignment list which is available for access for each interference state of the terminal, and transmits the frequency assignment list to the terminal via a control channel, the terminal measures an interference or noise level for a signal from neighboring base stations and generates interference information corresponding to the measured value, selects specific frequency assignment information from among the frequency assignment list based on the interference information, transmits the selected frequency assignment information to the base station, and the base station assigns the radio resource to the terminal based on the selected frequency assignment information.

According to various embodiments, the base station may include the frequency assignment list in a system information block of a broadcast control channel and transmit to the terminal.

According to various embodiments, the terminal may select the specific frequency assignment information to minimize interference from neighboring base stations.

According to various embodiments, a radio resource assignment system may include a base station configured to assign a radio resource, and at least one terminal located in a coverage of the base station, wherein the terminal measures the interference or noise level for a signal from neighboring base stations and generates interference information corresponding to the measured value, includes information corresponding to the interference information in a specific frame of a random access channel, transmits the specific frame to the base station, and the base station assigns the radio resource to the terminal based on the information corresponding to the interference information included in the specific frame.

According to various embodiments, the terminal may include specified information in the specific frame when the terminal is in a state of interference.

According to various embodiments, a radio resource assignment system may include a base station configured to assign a radio resource, and at least one terminal located in a coverage of the base station, wherein the terminal measures the interference or noise level for a signal from neighboring base stations and generates base station interference information based on the measured value, transmits the base station interference information to the base station via a common control channel, and the base station assigns the radio resource to the terminal based on the base station interference information.

According to various embodiments, the terminal includes information of at least one base station from which the terminal is affected by the interference from among the neighboring base stations in the base station interference information.

According to various embodiments, the terminal includes the base station interference information in a radio resource control connection request message and transmits the message.

As described above, the method of operating a base station according to an embodiment of the present disclosure may include an operation of defining an FA list which is available for access for each interference state of the terminal, an operation of transmitting the FA list to the terminal via a control channel, an operation of extracting, by the terminal, the FA list provided form the base station, an operation of measuring, by the terminal, a SINR value from neighboring base stations and generating interference information by a corresponding value, an operation of selecting, by the terminal, an optimal radio resource from among the FA list provided form the base station based on the generated interference information, an operation of transmitting, by the terminal, the selected FA information to the base station in an initial access process, and an operation of removing interference based on base station information and being assigned an optimal radio resource.

The aforementioned procedure of removing interference based on the terminal interference information and being assigned an optimal radio resource may, firstly, include an operation of generating, by the terminal, interference information by the SINR value from the neighboring base stations, an operation of defining Group C in a RACH Preamble that is an initial access process in order to transmit the generated interference information to the base station and transmitting a corresponding message to the base station if interference exits, and an operation of considering that, by a corresponding base station, a corresponding terminal is affected by the interference if the corresponding base station receives the Group C in the RACH Preamble from the terminal and allocating an optimal radio resource that can remove the interference.

In addition, secondly, the procedure of being assigned an optimal radio resource may include an operation of generating, by the terminal, interference information by the SINR value from the neighboring base stations, an operation of transmitting, by the terminal, Interference Info (information on all base stations from which all terminals are currently affected by interference) in the RRC Connection Request via the UL CCCH after the RACH Preamble procedure for the generated interference information, and an operation of analyzing, by a corresponding base station, the Interference Info of the RRC Connection Request message and selecting a radio bandwidth range that can remove the interference of a corresponding terminal to assign an optimal resource.

The communication system according to the method proposed in the present disclosure may measure the interference state of the current terminal and assign optimal resource that removed the interference by using corresponding information.

In addition, the communication system according to the method proposed in the present disclosure may assign optimal resource, thereby providing a smooth wireless service to a corresponding user (or terminal), and distributing a traffic load concentrated on a specific FA.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for assigning a radio resource, the method comprising:
measuring an interference or a noise level for a signal outputted from neighboring base stations and generating interference information corresponding to the measured value;
receiving a frequency assignment list which is available for access for each interference state of a terminal from a serving base station via a control channel;
selecting specific frequency assignment information from among the frequency assignment list based on the interference information;
transmitting the selected frequency assignment information to the base station; and
being assigned the radio resource by the base station based on the selected frequency assignment information.

2. The method of claim 1, wherein receiving a frequency assignment list comprises receiving a frequency assignment list included in a system information block of a broadcast control channel.

3. The method of claim 1, wherein receiving a frequency assignment list comprises receiving a first frequency assignment list which can be selected by a terminal when an interference from the neighboring base stations exists and a second frequency assignment list which can be selected when the interference from the neighboring base stations does not exist.

4. The method of claim 1, wherein receiving a frequency assignment list comprises selecting the specific frequency assignment information to minimize the interference from the neighboring base stations.

5. A method for assigning a radio resource, the method comprising:
measuring an interference or a noise level for a signal outputted from neighboring base stations and generating interference information corresponding to the measured value;
including information corresponding to the interference information in a specific frame of a random access channel;
transmitting the specific frame to a serving base station; and
being assigned the radio resource by the base station based on the information corresponding to the interference information included in the specific frame.

6. The method of claim 5, wherein including information comprises including specified information in the specific frame when the terminal is in a state of interference.

7. The method of claim 6, wherein including specified information in the specific frame comprises including specific group information in a preamble message of the random access channel.

8. A method for assigning a radio resource, the method comprising:
measuring an interference or a noise level for a signal from neighboring base stations and generating base station interference information based on the measured value;
transmitting the base station interference information to a serving base station via a common control channel; and
being assigned the radio resource by the base station based on the base station interference information.

9. The method of claim 8, wherein generating base station interference information comprises including information of at least one base station from which the terminal is affected by the interference from among the neighboring base stations in the base station interference information.

10. The method of claim 8, wherein transmitting the base station interference information comprises including the base station interference information in a radio resource control connection request message and transmitting the message.
